(19) United States
(12) Patent Application Publication
(10) Pub. No.: US 2020/0067296 A1
(43) Pub. Date: Feb. 27, 2020

(54) ADJUSTABLE GANG BOX

(71) Applicant: Cerro Wire LLC, Hartselle, AL (US)

(72) Inventors: Michael Howard, Chicago, IL (US); Kenneth LeVey, Chicago, IL (US)

(21) Appl. No.: 16/547,137

(22) Filed: Aug. 21, 2019

Related U.S. Application Data
(60) Provisional application No. 62/720,619, filed on Aug. 21, 2018.

(51) Int. Cl. H02G 3/10; H02G 3/08

(52) U.S. Cl. CPC H02G 3/10; H02G 3/081

(57) ABSTRACT

An adjustable gang box includes a bracket configured to be secured to a fixed structural component and a receptacle having a sidewall defining an inner volume. The bracket includes a first guide and the receptacle includes a second guide configured to engage the first guide. The receptacle is movable relative to the bracket by way of the engagement between the first guide and the second guide. The receptacle and the bracket can include cooperating members to secure the receptacle at a desired depth relative to a wall or stud to which the gang box is mounted.

### CROSS-REFERENCE TO RELATED APPLICATION DATA

This application claims the benefit of and priority to Provisional U.S. Patent Application Ser. No. 62/720,619, filed Aug. 21, 2018, titled Adjustable Gang Box, the disclosure of which is incorporated herein in its entirety.

### BACKGROUND

The present disclosure relates an electrical box, and in particular a gang box configured to be adjusted relative to a structural element.

Electrical boxes are commonly used to house electrical components. One type of an electrical box is commonly referred to as a “gang box.” A known gang box may be secured to a stud, or similar structural component, before a wall panel is secured to the stud. However, it is difficult to accurately position the gang box relative to the wall panel because the gang box is fixed. For example, the gang box may be undesirably recessed relative to the wall panel, or conversely, project outward from the wall panel.

As will be understood, an overly recessed or overly projecting gang box can be problematic. This is especially true when mounting, for example, switches in the gang box. Further, there can be aesthetic issues in that switches may not sit properly (e.g., flush) relative to the wall on which the switch and switch cover plate is mounted.

Accordingly, it is desirable to provide a gang box which may be adjusted relative to a wall panel to achieve a desired positioning relative to the wall panel or stud to which is it secured. Desirably, such a gang box can be locked into position relative to the wall panel or stud.

### SUMMARY

According to one embodiment, an adjustable gang box includes a bracket configured to be secured to a fixed structural component and a receptacle having a sidewall and defining an inner volume. The bracket includes a first guide and the receptacle includes a second guide configured to engage the first guide. The receptacle is movable relative to the bracket by way of the engagement between the first guide and the second guide.

In one embodiment, one of the first guide and the second guide may be a groove and the other of the first guide and the second guide may be a projection configured to be received in the groove. In one embodiment, the bracket may be substantially L-shaped. In one embodiment, the first guide may include upper and lower first guides and the second guide may include upper and lower second guides. In one embodiment, the adjustable gang box may further include an adjustment member mounted between the bracket and the receptacle and configured to move the receptacle relative to the bracket.

In an embodiment, the bracket and the receptacle have cooperating locking members. The cooperating locking members can be, for example, detents or projections and movable fingers. The movable fingers engage the detents or projections in a locked state and disengage from the detents or fingers in an unlocked state. The receptacle can include a locking channel and the detents or projections can be formed in the locking channel.

In embodiments, wherein the adjustment member includes a threaded member mounted to the receptacle. In embodiments, one or more securing projections can extend rearwardly from the bracket. The receptacle can include an open end and the bracket can include a leg generally parallel to the open end. The one or more securing projections can extend rearwardly from the leg.

These and other features and advantages of the present invention will be apparent from the following detailed description, in conjunction with the appended claims.

### BRIEF DESCRIPTION OF THE DRAWINGS

FIG. 1 is a perspective view of an adjustable gang box according to an embodiment.

FIGS. 2A-2C are perspective views (FIGS. 2A and 2B) and an exploded view (FIG. 2C of another embodiment of the adjustable gang box;

FIGS. 3A and 3B are top and perspective views of the gang box of FIGS. 2A-C shown in the unlocked and locked states;

FIG. 4 is a perspective view of yet another embodiment of the adjustable gang box; and

FIG. 5 is a perspective view of still another embodiment of the adjustable gang box.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

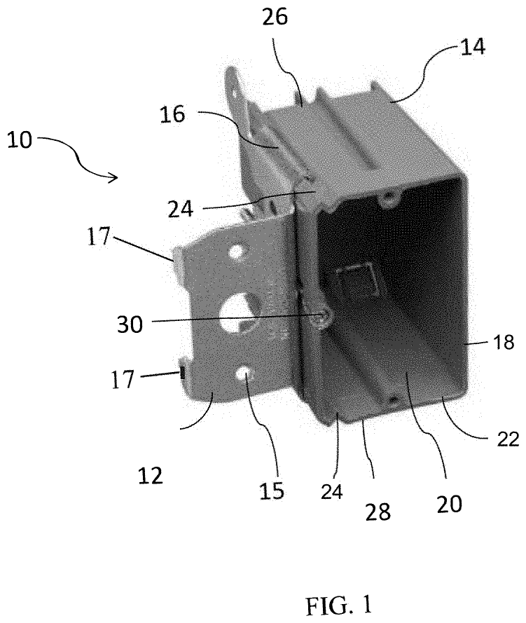

FIG. 1 is a perspective view showing an adjustable gang box 10 according to an embodiment. In one embodiment, the adjustable gang box 10 includes, generally, a bracket 12 and a receptacle 14. In an embodiment, the bracket 12 includes one or more fastening openings 15 configured to receive a fastener (not shown) to secure the bracket 12 to a relatively fixed structural component, such as a stud of a wall assembly. In an embodiment, the bracket can include securing prongs or projections (not shown in this figure) extending from a rear side that can be driven directly into the stud or the like for securing the gang box 10 to the stud. The securing prongs or projections can eliminate the need for fasteners to secure the gang box 10 in place. In embodiments, the bracket 12 may also flanges 17 that abut the opposite side of the stud to properly orient and position the gang box 10 in place. In one embodiment, the bracket 12 may be substantially L-shaped. In one embodiment, the bracket 12 may also include a first guide 16. In one embodiment, bracket 12 may include upper and lower first guides 16.

The receptacle 14 includes a sidewall 18 defining an inner volume 20 configured to receive, for example, one or more electrical components (not shown). The receptacle 14 may also include a substantially open front side 22.

In one embodiment, the receptacle 14 further includes a second guide 24. In one embodiment, the receptacle 14 may include upper and lower second guides 24 at upper and lower sides 26, 28, respectively, of the receptacle.

The first and second guides 16, 24 are configured for movable engagement with one another. For example, the second guide 24 may slide relative to the first guide 16. In one embodiment, one of the first guide 16 and the second guide 24 is a groove and the other of the first guide 16 and the second guide 24 is a projection configured to be received in the groove. For example, the second guide 24 may be formed as groove in the sidewall 18 of the receptacle 14, and the first guide 16 may be a projection received in the groove. In one embodiment, the first guide 16 is also configured to support the receptacle 14 on the bracket 12 by way of engagement with the second guide 24. In one embodiment, the first guide 16 and the second guide 24 may have substantially mating profiles and form a track.

In the embodiments above, a wall panel (not shown) may be secured to the stud. The receptacle 14 (by way of adjusting the depth of the gang box 10 along the stud) may be adjusted relative to the bracket 12 and the wall panel to position the receptacle 14 at a suitable location relative to the wall panel. The gang box 10 may be slid, by hand, along the bracket 12, to position the gang box 10 at a desired depth relative to the wall panel.

In one embodiment, the receptacle 14 may further include an adjustment member 30. The adjustment member 30 may be mounted between the bracket 12 and the receptacle 14 and is configured to move the receptacle 14 relative to the bracket 12.

For example, in one embodiment, the adjustment member 30 may be a threaded adjustment member configured for threaded engagement with a base member (not shown). The threaded adjustment member 30 may be mounted to one of the bracket 12 and the receptacle 14 and the base member may be included on the other of the bracket 12 and the receptacle 14. Accordingly, rotation of the threaded adjustment member 30 is configured to move the receptacle 14 relative to bracket 12.

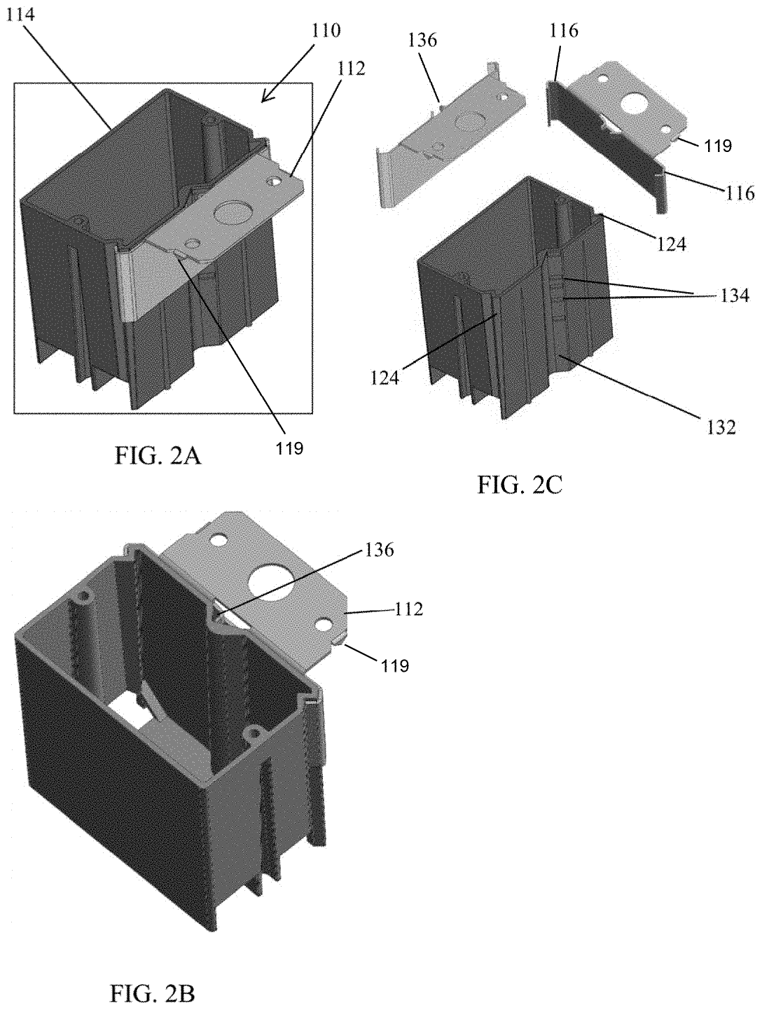

Referring to FIGS. 2A-2C, there is shown another embodiment of the adjustable gang box 110 and bracket 112. In this embodiment, the box receptacle 114 and bracket 112 include the first and second guides 116, 124 that mate and cooperate with one another to adjust the depth of the receptacle 114 relative to the bracket 112 (and the wall in which the receptacle is positioned or the stud on which the receptacle is mounted). In embodiments, the bracket 112 can include securing prongs or projections 119 extending from a rear side that can be driven directly into the stud or the like for securing the gang box 110 to the stud. The securing prongs or projections 119 can eliminate the need for fasteners to secure the gang box 110 in place.

In this embodiment, the receptacle 114 includes a locking track 132 having one or more first locking members 134 and the bracket 112 includes one or more second locking members 136. The one or more first and second locking members 134, 136 engage each other to lock or secure the receptacle at a desired depth relative to the wall or stud. In an embodiment, the locking track 132 is a V-shaped track that is parallel to the first and/or second guides 116, 124 and the one or more first locking members 134 are detents or projections formed in the track 132.

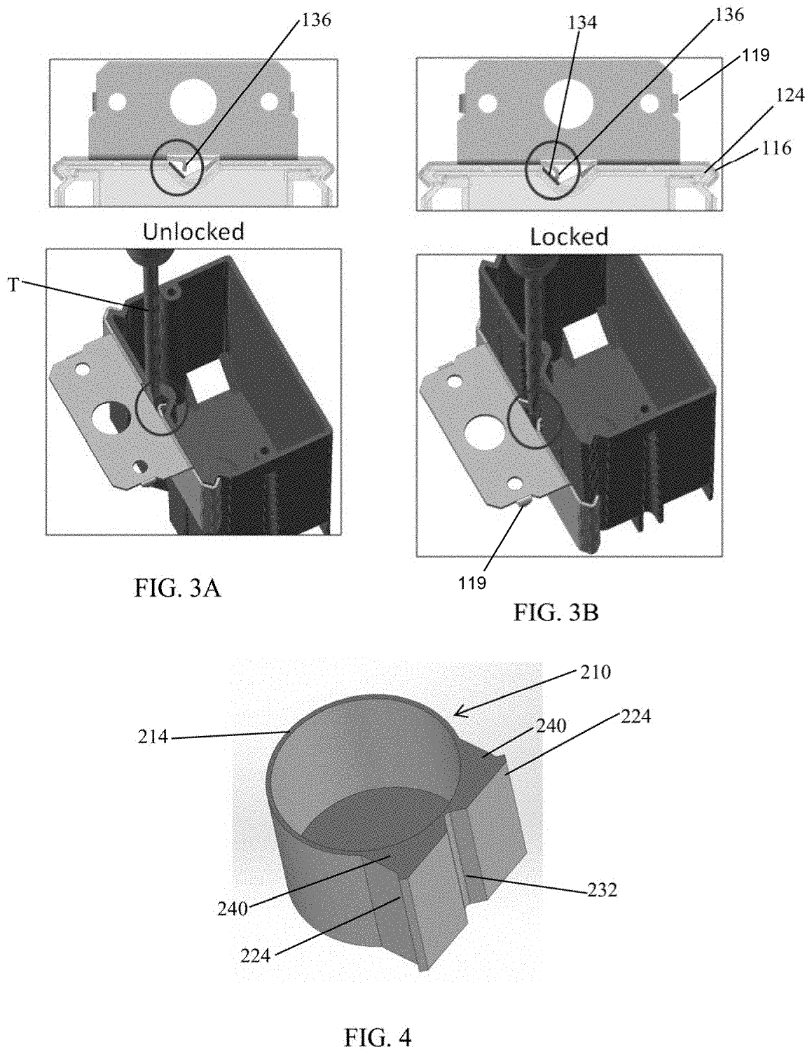

In an embodiment the one or more second locking members 136 are one or more movable fingers that can be bent outwardly to engage the detents or projections 134 and can be moved inwardly to free the fingers 136 from the detents or projections 134 so that the receptacle 114 can be moved along the bracket 112 to adjust the depth of the receptacle 114 relative to the wall or stud. FIGS. 3A and 3B show the movable fingers 136 in the unlocked and locked positions, respectively. FIGS. 3A and 3B also show how the fingers 136 are moved between the locked and locked positions by using a screw driver or other rigid tool T having a shaft sufficiently strong (and rigid) to bend the fingers 136 outwardly to engage the detents or projections 134. Likewise, the fingers 136 can be bent inwardly to unlock the fingers 136 or disengage the fingers 136 from the detents or projections 134.

FIG. 4 illustrates a gang box 210 having a round receptacle 214 that can be used, for example, in a ceiling for a ceiling fixture. The round receptacle 214 includes second guides 224 formed as part of buttress walls 240 formed on an outer surface of the round receptacle 214 wall. The buttress walls 240 provide sufficient strength to the round wall and a receiving region for engagement with the bracket first guides (not shown, but refer to FIGS. 2A-3C) to mount the receptacle 214. The round receptacle 214 can include a locking track 232, such as the illustrated V-shaped track having one or more first locking members (not shown, but refer to FIG. 2C) to cooperate with the bracket second locking members.

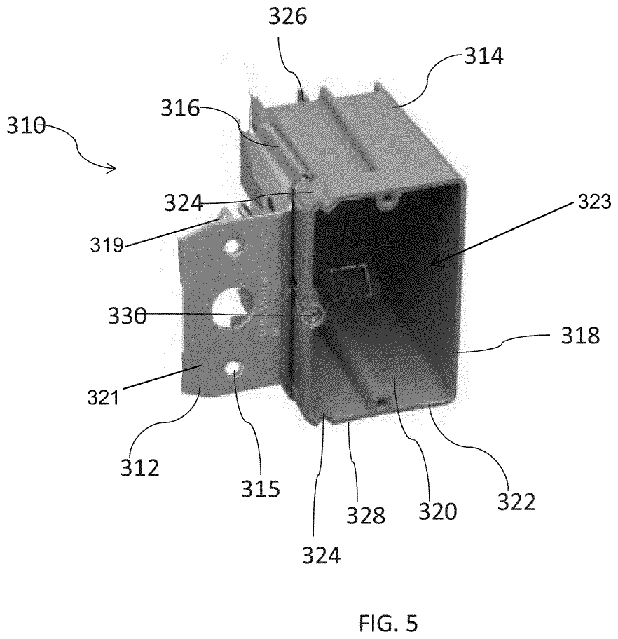

Referring now to FIG. 5, there is shown still another embodiment of the adjustable gang box 310. The gang box 310 includes, generally, a bracket 312 and a receptacle 314. In an embodiment, the bracket 312 is generally L-shaped and includes one or more fastening openings 315 in a leg 321 thereof configured to receive a fastener (not shown) to secure the bracket 312 to a relatively fixed structural component, such as a stud of a wall assembly. The leg 321 is generally parallel to an opening 323 in the receptacle 314. As illustrated, the bracket 312 can include securing prongs or projections 319 extending from the leg 321 toward a rear side that can be driven directly into the stud or the like for securing the gang box 310 to the stud. The securing prongs or projections 319 can eliminate the need for fasteners to secure the gang box 310 in place. In one embodiment, the bracket 312 may be substantially L-shaped. In one embodiment, the bracket 312 may also include a first guide 316. In one embodiment, bracket 312 may include upper and lower first guides 316.

The receptacle 314 includes a sidewall 318 defining an inner volume 320 configured to receive, for example, one or more electrical components (not shown). The receptacle 314 may also include a substantially open front side 322.

In an embodiment, the receptacle 314 further includes a second guide 324. The receptacle 314 may include upper and lower second guides 324 at upper and lower sides 326, 328, respectively, of the receptacle 314.

The first and second guides 316, 324 are configured for movable engagement with one another. For example, the second guide 324 may slide relative to the first guide 316. In one embodiment, one of the first guide 316 and the second guide 324 is a groove and the other of the first guide 316 and the second guide 324 is a projection configured to be received in the groove. For example, the second guide 324 may be formed as groove in the sidewall 318 of the receptacle 314, and the first guide 316 may be a projection received in the groove. In an embodiment, the first guide 316 is also configured to support the receptacle 314 on the bracket 312 by way of engagement with the second guide 324. In one embodiment, the first guide 316 and the second guide 324 may have substantially mating profiles and form a track.

In the embodiments above, a wall panel (not shown) may be secured to the stud. The receptacle 314 (by way of adjusting the depth of the gang box 310 along the stud) may be adjusted relative to the bracket 312 and the wall panel to position the receptacle 314 at a suitable location relative to the wall panel. That is, the receptacle 314 by way of adjusting the depth of the gang box 310 along the stud may be adjusted relative to the bracket 312 and the wall panel to position the receptacle 314 flush or near-flush with an outer surface of the wall panel or positioned as desired depending upon the desired installation.

As illustrated in FIG. 5, the receptacle 314 may further include an adjustment member 330. The adjustment member 330 may be mounted between the bracket 312 and the receptacle 314 and is configured to move the receptacle 314 relative to the bracket 312.

For example, in one embodiment, the adjustment member 330 may be a threaded adjustment member, such as a screw, configured for engagement with a threaded base member (not shown) on the bracket 312. That is, the threaded member 330 and the threaded base member are mating members. The threaded adjustment member 330 may be mounted to one of the bracket 12 and the receptacle 314 and the base member may be included on the other of the bracket 12 and the receptacle 14. Accordingly, rotation of the threaded adjustment member 30 is configured to move the receptacle 14 relative to bracket 12.

In an embodiment the threaded adjustment member 330 is mounted for rotation, but remains longitudinally fixed, and engages a threaded receptacle, such as a threaded opening (not shown) on the bracket so as facilitate movement of the bracket 312, along the depth of the receptacle 314. In this manner, for example, after affixing the bracket 314 to the wall stud, the adjustment member 330 can be used (as by rotating the member 330 with, for example a screw driver) to a desired depth relative to the stud and the wall to which the gang box 30 is mounted. It will be appreciated by those skilled in the art with reference to FIG. 5 that because the member is readily accessible depth of the gang box 310 relative to the stud or wall can be adjusted after the gang box 310 is installed in place on the stud with a wall covering, such as drywall, in place.

It is to be understood that features from any one of the embodiments described above may be implemented in, combined or used together with, or replace features from any of the other embodiments described above.

It is understood the various features from any of the embodiments above are usable together with the other embodiments described herein.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to orientation of various components, such as “upper” or “lower” is used for the purposes of example only, and does not limit the subject matter of the present disclosure to a particular orientation.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. An adjustable gang box comprising:
a bracket configured to be secured to a fixed structural component, the bracket having a first guide; and
a receptacle having a sidewall defining an inner volume and a second guide configured to engage the first guide,
wherein the receptacle is movable relative to the bracket by way of the engagement between the first guide and the second guide.

2. The adjustable gang box of claim 1, wherein one of the first guide and the second guide is a groove and the other of the first guide and the second guide is a projection configured to be received in the groove.

3. The adjustable gang box of claim 1, wherein the bracket is substantially L-shaped.

4. The adjustable gang box of claim 1, wherein the first guide includes upper and lower first guides and the second guide includes upper and lower second guides.

5. The adjustable gang box of claim 1, further comprising an adjustment member mounted between the bracket and the receptacle and configured to move the receptacle relative to the bracket.

6. The adjustable gang box of claim 1, wherein the bracket and the receptacle have cooperating locking members.

7. The adjustable gang box of claim 6, wherein the cooperating locking members include detents or projections and movable fingers, the movable fingers engaged with the detents or projections in a locked state and disengaged from the detents or fingers in an unlocked state.

8. The adjustable gang box of claim 7, wherein the receptacle includes a locking channel and wherein the detents or projections are formed in the locking channel.

9. The adjustable gang box of claim 5, wherein the adjustment member includes a threaded member mounted to the receptacle.

10. The adjustable gang box of claim 1, further including one or more securing projections extending rearwardly from the bracket.

11. The adjustable gang box of claim 3, wherein the receptacle includes an open end, and wherein the bracket includes a leg generally parallel to the open end.

12. The adjustable gang box of claim 11, further including one or more securing projections extending rearwardly from the leg.
